(19) United States
(12) Patent Application Publication
(10) Pub. No.: US 2021/0277314 A1
(43) Pub. Date: Sep. 9, 2021

(54) DEMULSIFYING AGENTS FOR CRUDE OIL BASED ON RANDOM ALKYLACRYLIC-AMINOALKYLACRYLIC-CARBOXYALKYLACRYLIC TERPOLYMERS OF CONTROLLED MOLECULAR MASS

(71) Applicant: INSTITUTO MEXICANO DEL PETROLEO, Mexico City (MX)

(72) Inventors: Cesar Andres FLORES SANDOVAL, Mexico City (MX); Flavio Salvador VAZQUEZ MORENO, Mexico City (MX); Fernando ALVAREZ RAMIREZ, Mexico City (MX); Gerardo ZAVALA OLIVARES, Mexico City (MX); Jessica Valeria FUENTES SANTIAGO, Mexico City (MX); Edgar Benedicto ZAMORA GUERRERO, Mexico City (MX); Citlally Janinne VARGAS MARTINEZ, Mexico City (MX)

(21) Appl. No.: 16/914,776

(22) Filed: Jun. 29, 2020

(30) Foreign Application Priority Data
Feb. 27, 2020 (MX) MX/A/2020/002212

(51) Int. Cl. C10G 33/04; C08F 220/18; C08F 220/34; C08F 220/28; C08F 2/22

(52) U.S. Cl. CPC C10G 33/04; C08F 220/18; C08F 2/22; C08F 220/283; C08F 220/34

(57) ABSTRACT

A problem the oil industry faces is the presence of great water and salt amounts in crude oil streams, which cannot be easily removed by conventional dehydrating polymers. Moreover, the acid stimulation of wells evokes the chemical degradation of the polyethers and phenolic resins used as demulsifiers, drastically reducing their water and salt removal efficiency. Disclosed herein are new terpolymers which are combinations of three derivative monomers from alkyl acrylate, aminoalkyl acrylate, and carboxyalkyl acrylate, synthesized via emulsion polymerization by semi-continuous process under starving feed conditions, in order to ensure both the homogeneity of the polymer chains and the randomness of the monomers. The dissolutions of the random terpolymers have displayed a comparable, and even superior, water removal efficiency when dosed in light or heavy crude oils. The random alkylacrylic-aminoalkylacrylic-carboxyalkylacrylic terpolymers present an outstanding performance as emulsion breakers, water droplets coalescers, and aqueous phase clarifiers.

### CROSS-REFERENCE TO RELATED APPLICATIONS

The present disclosure claims priority to Mexican Patent Application No. MX/a/2020/002212, filed Feb. 27, 2020, the entire disclosure of which is hereby incorporated by reference herein.

### TECHNICAL FIELD

The present disclosure is related to new random terpolymers based on alkyl acrylate, aminoalkyl acrylate, and carboxyalkyl acrylate, obtaining process and application as crude oil demulsifiers, more specifically, to destabilize the water-in-crude oil emulsions, with the aim of removing the emulsified water and the dissolved salts in the aforementioned, in the triphasic separation units for crude oils with API densities from 3 to 40° API.

### BACKGROUND

Nowadays, oil industry deals with the problem of contamination with great amounts of water and salts. Most of the extracted crude oils contain huge amounts of asphaltenes and resins, which stabilize the dispersed water in the crude oil. Therefore, the formed emulsions are more and more stable; hence, the destabilization process of the water/crude oil interface is harder. The chemical treatment is widely used in the oil industry to remove the emulsified water using chemical products that act as demulsifying agents. The main target of a demulsifying agent is to destabilize the water/crude oil interface in order to induce the coalescence of the water droplets, evoking the separation of the phases. However, since the production of heavy and extra-heavy crude oils is constantly increasing, it is essential to have more efficient demulsifiers to remove the highest amount of emulsified water.

The oil industry employs as dewatering agents of crude oils: triblock polyethers EO-PO-EO [1,2], resins, sulfonates, polyglycols, polyamines, di-epoxides, urethanes, polyesters, polyalkylenes, polyesteramines, and oxyalkylates.

Concerning the triblock bipolymers EO-PO-EO, it has been proved that their performance to remove the emulsified water depends on:
1) the chemical structure of the triblock bipolymer,
2) the monomeric composition, and
3) the average molecular mass (length of the polymeric chain) [3,4].

Some vinylic polymers have been employed as W/O and O/W emulsion breakers. The U.S. Pat. No. 4,614,593 [5] protects the use of monoallylamine polymers as demulsifying agents, which were tested in synthetic O/W emulsions, using as disperse phase an engine commercial oil SAE 10W30 and as stabilizing agents a mixture of dodecylic and tetradecylic alcohols. Nevertheless, it should be pointed out that these types of emulsions are easier to destabilize than the crude oil emulsions, which are directly stabilized by asphaltenes.

The U.S. Pat. No. 5,156,767 “Emulsion breaking using alkylphenol-polyethylene oxide-acrylate polymer coated coalescer material” [6] describes the use of a polymer that contains alkylphenol, ethylene oxide, and acrylate; which shows effectiveness to break water-in-crude oil emulsions. The performance of these polymers was determined using a mixture of crude oil Hutton and brine from Tisdale field.

On the other hand, concerning demulsifiers based on acrylics, the CN Patent 101,255,354 [7] reports the performance of butyl acrylate and acrylic acid bipolymers as dehydrating agents of crude oil. The applicants observed a good behavior of the products regarding their emulsion breaking and water clarifying capacities.

In the U.S. Pat. No. 5,472,617 [8] is described the synthesis of block bipolymers with acrylic and oxyalkylates (ethylene and propylene oxides derivatives) sequences. Nonetheless, the synthesis process comprises numerous stages for the preparation of the comonomers and subsequents. Another inconvenient of these bipolymers is the use of organic solvents, such as toluene or xylene as dilution media during synthesis.

The U.S. Pat. No. 5,100,582 [9] reports a tetrapolymer based on methyl methacrylate, butyl acrylate, acrylic acid, and methacrylic acid, as well as a pentapolymer synthesized from methyl methacrylate, butyl acrylate, acrylic acid, methacrylic acid, and styrene, as destabilizers of water-in-oil emulsions. The polymers turned out to be water-soluble and were assessed in a mixture of heptane and toluene as a “replica of crude oil”. It is important to note that the stabilizing effect of asphaltenes was not taken into account in the water-in-oil emulsions, since it cannot be emulated with the mixture of organic solvents used to evaluate the performance of the tetrapolymer and pentapolymer. Therefore, the efficiency of these chemical compounds as dewatering agents of crude oil is still far from reality.

In parallel way, A. M. Atta et al. [10] reported the use of acrylic type poly-ionic liquids to promote the interface destabilization between water and heavy crude oil. Bipolymers were prepared using solution polymerization, employing tetrahydrofuran as solvent. It should be highlighted that the average molecular masses are not mentioned in the synthesis procedure. Polymers displayed good clarification of the removed water.

Ramirez Gutiérrez in his master thesis titled “Theoretical-experimental study of the potential for dehydration of heavy crudes induced by addition polymers” [11] showed evidence of the demulsifying activity of vinyl-acrylic bipolymers in extra-heavy crude oils. These bipolymers were synthesized through emulsion polymerization, which employs water instead of organic solvents. The vinyl-acrylic bipolymers showed a good performance to remove the emulsified water in heavy crude oils.

In the engineering thesis of González Palacios [12] is described the synthesis of bipolymers from two alkylacrylic monomers, which were evaluated as demulsifying agents. It was observed that there is a great influence of the molecular mass of the bipolymers in their performance as dehydrating agents of crude oils. Notwithstanding, even though these acrylic bipolymers were efficient as demulsifying agents, it was necessary to use dosages above 1500 ppm.

A similar study was developed by Martínez Gallegos [13], who reported the use of bipolymers based on 2-carboxyethyl acrylate (F) and 2-(dimethylamino)ethyl methacrylate (E), with F/E weight ratio of: 50/50 wt % and 70/30 wt %, as dewatering agents of crude oil. Such bipolymers proved to be insoluble in organic solvents; consequently, they were dissolved in water at basic pH. Although with the combination of carboxyacrylic and aminoacrylic monomers, high water removal efficiencies were reached, the need to add these acrylic demulsifiers in aqueous solutions constitutes a huge drawback for field application to destabilize water-in-crude oil emulsions. From an environmental point of view, the hydrophilicity of these carboxyacrylic-aminoacrylic bipolymers also represents a difficulty, in accordance with Bolto & Gregory in “Organic polyelectrolytes in water treatment” [14], the fact that the demulsifier remains in the aqueous phase constitutes a serious problem. In the oil industry is required that the demulsifying agents remain in the oil phase once their function is fulfilled.

On the other hand, Garcia Jiménez in the thesis “Theoretical-experimental study of the water/crude oil emulsions breaking through acrylic based copolymers” [15] and Chávez Mora in the thesis “New demulsifying acrylic based agents for the water/crude oil emulsion removal” [16], reported a good behavior of certain random acrylic based bipolymers as dewatering agents, which can be dissolved in organic solvents. These bipolymers showed a good performance as water removers in light and heavy crude oils. It should be noted that nowhere in both documents is described the chemical structures and ratio of monomers employed to synthesize the dewatering bipolymers for crude oil; being impossible to infer the combinations of the numerous acrylic monomers available on the market that could be used to prepare the reported dehydrating agents.

In another pair of theses, Vargas Martínez in “Synthesis and evaluation of random acrylic terpolymers for the dewatering of extra-heavy crude oils” [17] and Zamora Guerrero in “Synthesis, characterization and evaluation as demulsifying agents of petroleum of acrylic copolymers and terpolymers” [18] describe the dewatering activity in crude oil of terpolymers based on acrylic and methacrylic monomers. The synthesized terpolymers displayed a good performance in the removal of emulsified water in heavy crude oils. However, it should be pointed out that none of these works reported the chemical structure and ratio of monomers employed to synthesize the dehydrating terpolymers, being impossible to infer the combinations of the numerous acrylic and methacrylic monomers available on the market that are capable of demulsifying crude oils. Even less, it can be inferred the specific combinations of three monomers that could show demulsifying activity in crude oil.

Finally, in the patent application MX/a/2016/016226 [19] is described the use of random bipolymers based on alkylacrylic and aminoacrylic monomers as breaking agents of water-in-crude oil emulsions, mainly for crude oils with API densities ranging from 10 to 40° API.

In contrast to the aforementioned documents, the present disclosure is related to new random terpolymers based on alkyl acrylate, aminoalkyl acrylate, and carboxyalkyl acrylate, obtaining process and usage, with properties as breakers of water-in-crude oil emulsions, coalescers of water droplets and clarifiers of the aqueous phase. The synthesis of these demulsifiers of crude oil is performed through emulsion polymerization by semi-continuous process, developed in the Mexican Institute of Petroleum and described in the patent documents MX 338861 B [20], Mx/a/2013/014352 [21], and U.S. Pat. No. 9,120,885 [22], the disclosures of which are expressly incorporated by reference herein. Emulsion polymerization was carried out under starving feed conditions, which guarantee a random distribution of acrylic terpolymers. The synthesis procedure includes the use of a chain transfer agent which allows controlling the average molecular mass of polymer chains. This molecular parameter is of great importance, since the dehydration efficiency of light or heavy crude oils depends largely on it. The right quantities of the alkyl acrylic monomer on terpolymer enable its dissolution in crude oil; whereas the aminoacrylic and carboxyacrylic units interact with the aqueous phase. The ratios of alkylacrylic, aminoacrylic, and carboxyacrylic monomers were adjusted in order to synthesize terpolymers soluble in the organic phase to be directly dosed in crude oil, avoiding any risk of being dragged in the separated water [14]. In contrast with other demulsifiers reported in the literature, these terpolymers based on alkyl acrylate, aminoalkyl acrylate, and carboxyalkyl acrylate were directly assessed in light, heavy, and extra-heavy crude oils. The molecular characteristics of the new random terpolymers based on alkyl acrylate, aminoalkyl acrylate, and carboxyalkyl acrylate, specifically their composition and average molecular mass, can be adjusted according to the characteristics of each crude oil, optimizing their performance as demulsifying agents and showing a better cost-benefit ratio than the dehydrating agents available in the market.

### BIBLIOGRAPHIC REFERENCES

[1] U.S. Pat. No. 2,425,845, Aug. 19, 1947, “Mixtures of polyoxyalkylene diols and methods of making such mixtures”, Toussaint and Fife.
[2] U.S. Pat. No. 3,334,038, Aug. 1, 1967, “Phase separation process”, Roy.
[3] Fuel 103 (2013) 356-363, “Demulsifying Super-Heavy Crude Oil with Bifunctionalized Block Copolymers”, G. Cendejas et al.
[4] Energy & Fuels 25 (2011) 562-567, “Dissipative Particle Dynamics (DPD) Study of Crude Oil-Water Emulsions in the Presence of a Functionalized Co-polymer”, F. Alvarez et al.
[5] U.S. Pat. No. 4,614,593, Sep. 30, 1986, “Demulsification of oil-in-water emulsions”, Roark.
[6] U.S. Pat. No. 5,156,767, Oct. 20, 1992, “Emulsion breaking using alkylphenol-polyethylene oxide-acrylate polymer coated coalescer material”, Fitzgerald et al.
[7] CN Patent 101,255,354, Jun. 4, 2011, “Non-polyether type thick oil demulsifying agent and preparation thereof”, Zesheng Lian et al.
[8] U.S. Pat. No. 5,472,617, Dec. 5, 1995, “Method of demulsifying crude oil and water mixtures with copolymers of acrylates or methacrylates and hydrophilic commonomers”, Berthold et al.
[9] U.S. Pat. No. 5,100,582, Mar. 31, 1992, “Water soluble polymer as water-in-oil demulsifier”, Bhattacharyya.
[10] Journal of Molecular Liquids 222 (2016) 680-690, “Dipoles Poly(ionic liquids) Based on 2-Acrylamido-2-Methylpropane Sulfonic Acid-co-Hydroxyethyl Methacrylate for Demulsification of Crude Oil Water Emulsions”, A. M. Atta et al.
[11] Master in Science thesis, Instituto Mexicano del Petróleo, July 2014, pp 120-126, “Theoretical-experimental study of the potential for dehydration of heavy crudes induced by addition polymers”, David Ramirez Gutiérrez.
[12] Industrial Chemical Engineering thesis, Instituto Politécnico Nacional (IPN)—Escuela Superior de Ingeniería Química e Industries Extractives (ESIQIE), December 2015, pp 66, 117-130 and 136, “Synthesis of alkyl acrylate base copolymers via emulsion polymerization as demulsifying agents in Mexican heavy crude oils”, Norma González Palacios.
[13] Industrial Chemical Engineering thesis, Instituto Politécnico Nacional (IPN)—Escuela Superior de Ingeniería Química e Industries Extractives (ESIQIE), September 2016, pp 82-84, “Novel oil dehydration process using random acrylic copolymers”, Alba Analí Martínez Gallegos.
[14] Water research 41 (2007) 2301-2324, “Organic Polyelectrolytes in Water Treatment”, B. Bolto and J. Gregory.
[15] Industrial Chemical Engineering thesis, Instituto Politécnico Nacional (IPN)—Escuela Superior de Ingeniería Química e Industries Extractives (ESIQIE), August 2016, pp 134-135, “Theoretical-experimental study of the breaking of water in oil emulsions by means of acrylic-based copolymers”, Rodrigo de Jesús Garcia Jiménez.
[16] Industrial Chemical Engineering thesis, Instituto Politécnico Nacional (IPN)—Escuela Superior de Ingeniería Química e Industrias Extractivas (ESIQIE), May 2017, pp 129-130, “New acrylic based demulsifying agents for the removal of water in crude oil emulsions”, Marco Antonio Chávez Mora.
[17] Chemical Engineering thesis, Universidad Veracruzana (UV)—Facultad de Ciencias Químicas, December 2017, pp 41, “Synthesis and evaluation of random acrylic terpolymers for deydration of extra-heavy crude oils”, Citlally Janinne Vargas Martínez.
[18] Master in Science thesis, Instituto Mexicano del Petróleo (IMP), August 2018, pp 232, “Synthesis, characterization and evaluation as crude oil dehydrating agents of acrylic copolymers and terpolymers”, Edgar Benedicto Zamora Guerrero.
[19] Patent application MX/a/2016/016226, Dec. 8, 2016, “Demulsifiers for crude oils based on acrylic-aminoacrylic random copolymers of controlled molecular mass”, Hernández Carbajal et al.
[20] Patent application MX 338861, Apr. 28, 2016, “Formulation of random polymers to improve the flow of crude oil”, Castro Sotelo et al.
[21] Patent application MX 2013014352, Dec. 6, 2013, “Formulations of alkyl acrylate based homopolymers used as defoamers in heavy and extra-heavy crude oils”, Estrada Martínez et al.
[22] U.S. Pat. No. 9,120,885, Sep. 1, 2015, “Formulations of random polymers for improving crude petroleum flow”, Castro Sotelo et al.

### BRIEF DESCRIPTION OF THE FIGURES

FIG. 1 displays the performance of the random terpolymers based on alkyl acrylate/aminoalkyl acrylate/carboxyalkyl acrylate synthesized with 1 wt % (AAmC-1 series) and 2 wt % (AAmC-2 series) of transfer agent, respectively, and with different monomeric ratio as demulsifying agents in the extra-heavy crude oil of 7.55° API (CM1). All products were assessed at a dosage of 250 ppm.

FIG. 2 shows the bottle images and optical micrographs of the extra-heavy crude oil of 7.55° API (CM1) after the assessment of the AAmC 9551 acrylic terpolymer, the TOMAC ionic liquid, and the FDH-1 commercial formulation; at a dosage of 250 ppm.

FIG. 3 displays the performance of the random terpolymers based on alkyl acrylate/aminoalkyl acrylate/carboxyalkyl acrylate synthesized with 1 wt % (AAmC-1 series) and 2 wt % (AAmC-2 series) of transfer agent, respectively, and with different monomeric ratio as demulsifying agents in the extra-heavy crude oil of 7.55° API (CM1). All products were assessed at a dosage of 250 ppm.

FIG. 4 presents the bottle images and optical micrographs of the extra-heavy crude oil of 7.55° API (CM1) after the assessment of the AAmC 6132, AAmC 7122, AAmC 8112, and AAmC 9552 acrylic terpolymers; which were able to remove all the emulsified water, compared with the emulsified water removal of the TOMAC ionic liquid and the FDH-1 commercial formulation at a dosage of 250 ppm.

FIG. 5 presents the bottle images and optical micrographs of the extra-heavy crude oil of 7.55° API (CM1) after the assessment of the AAmC 6132, AAmC 7122, AAmC 8112, and AAmC 9552 acrylic terpolymers; which were able to remove all the emulsified water, compared with the emulsified water removal of the TOMAC ionic liquid and the FDH-1 commercial formulation at a dosage of 250 ppm.

FIG. 6 shows the performance of the random terpolymers based on alkyl acrylate/aminoalkyl acrylate/carboxyalkyl acrylate synthesized with 1 wt % (AAmC-1 series) and 2 wt % (AAmC-2 series) of transfer agent, respectively, and with different monomeric composition as demulsifying agents in the extra-heavy crude oil of 6.11° API (CM2). All products were assessed at a dosage of 500 ppm.

FIG. 7 displays the bottle images and optical micrographs of the extra-heavy crude oil of 6.11° API (CM2) after the assessment of the AAmC 6131 and AAmC 9551 acrylic terpolymers, compared with the TOMAC ionic liquid, and the FDH-1 commercial formulation, at a dosage of 500 ppm.

FIG. 8 shows the performance of the random terpolymers based on alkyl acrylate/aminoalkyl acrylate/carboxyalkyl acrylate synthesized with 1 wt % (AAmC-1 series) and 2 wt % (AAmC-2 series) of transfer agent, respectively, and with different monomeric composition as demulsifying agents in the extra-heavy crude oil of 6.11° API (CM2). All products were assessed at a dosage of 500 ppm.

FIG. 9 shows the bottle images and optical micrographs of the extra-heavy crude oil of 6.11° API (CM2) after the assessment of the AAmC 9552 acrylic terpolymer, the TOMAC ionic liquid, and the FDH-1 commercial formulation, at a dosage of 500 ppm.

FIG. 10 displays the performance of the random terpolymers based on alkyl acrylate/aminoalkyl acrylate/carboxyalkyl acrylate synthesized with 1 wt % (AAmC-1 series) and 2 wt % (AAmC-2 series) of transfer agent, respectively, and with different monomeric composition as demulsifying agents in the extra-heavy crude oil of 4.55° API (CM3). All products were assessed at a dosage of 1500 ppm.

FIG. 11 shows the bottle images and optical micrographs of the extra-heavy crude oil of 4.55° API (CM3) after the assessment of the AAmC 9551 acrylic terpolymer, the TOMAC ionic liquid, and the FDH-1 commercial formulation, at a dosage of 1500 ppm.

FIG. 12 displays the performance of the random terpolymers based on alkyl acrylate/aminoalkyl acrylate/carboxyalkyl acrylate synthesized with 1 wt % (AAmC-1 series) and 2 wt % (AAmC-2 series) of transfer agent, respectively, and with different monomeric composition as demulsifying agents in the extra-heavy crude oil of 4.55° API (CM3). All products were assessed at a dosage of 1500 ppm.

FIG. 13 presents the bottle images and optical micrographs of the extra-heavy crude oil of 4.55° API (CM3) after the assessment of the AAmC 9552 acrylic terpolymer, compared with the water removal of the TOMAC ionic liquid and the FDH-1 commercial formulation, at a dosage of 1500 ppm.

### DETAILED DESCRIPTION

The present disclosure is related to new random acrylate terpolymers based on alkyl acrylate/aminoalkyl acrylate/carboxyalkyl acrylate, obtaining process and usage as demulsifying agents of crude oil, more specifically to destabilize water-in-crude oil (W/O) emulsions, in order to remove the emulsified water and, consequently, the dissolved salts in water, in the triphasic separation units for crude oils with API densities between 3 and 40° API.

The random acrylic terpolymers based on alkyl acrylate/aminoalkyl acrylate/carboxyalkyl acrylate of this disclosure were synthesized as latex by an emulsion polymerization technique, which has been widely described in the patent document MX 338861 B [20], incorporated by reference herein; considering in the present disclosure that the weight amount of monomers in the addition tank to form a pre-emulsion, can vary as following: the monomer of alkyl acrylate can be between 50.0 and 99.0 wt %, the monomer of aminoalkyl acrylate can be in the range of 0.5 to 49.5 wt %, and the monomer of carboxyalkyl acrylate can vary in the interval of 0.5 and 49.5 wt %. Finally, the latex is submitted to a distillation process at a temperature between 80 and 120° C., in order to obtain a viscous liquid, which must be subsequently dissolved in an adequate organic solvent with boiling point between 35 and 200° C., such as dichloromethane, methanol, ethanol, isopropanol, chloroform, benzene, and its derivatives, toluene, xylene, turbosine, and naphtha; individually or as a mixture of the aforementioned, for its final use as demulsifying agent of crude oils between 3 and 40° API. The concentration of random acrylic terpolymer in solution can vary between 10.0 and 50.0 wt %, whereas the formulation is dosed in a range of 10 to 2,000 ppm.

Scheme 1 displays the chemical structure of the random acrylic terpolymers based on alkyl acrylate/aminoalkyl acrylate/carboxyalkyl acrylate, comprised in the present invention:

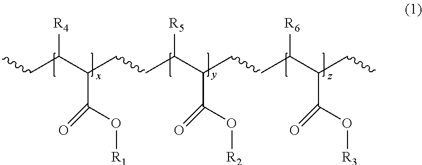

where:
R¹, R², R³, R⁴, R⁵, and R⁶ are independent radicals, represented by the groups mentioned below:
R¹═CH₃ (methyl), C₂H₅ (ethyl), C₄H₉ (n-butyl), C₄H₉ (iso-butyl), C₄H₉ (tert-butyl), C₅H₁₁ (pentyl), C₆H₁₃ (n-hexyl), C₆H₁₁ (di(ethyleneglycol)ethylether), C₈H₁₇ (2-ethylhexyl), C₉H₁₉ (3,5,5-trimethylhexyl), C₈H₁₇ (n-octyl), C₈H₁₇ (iso-octyl), C₈H₉ (ethyleneglycol phenylether), C₁₀H₂₁ (n-decyl), C₁₀H₂₁ (iso-decyl), C₁₀H₁₉ (10-undecenyl), C₁₀H₁₉ (tert-butylciclohexyl), C₁₂H₂₅ (n-dodecyl), C₁₈H₃₇ (n-octadecyl), C₈H₉O (2-phenoxyethyl), C₃H₇O (2-methoxyethyl), C₅H₁₁O₂ (2-(2-methoxyethoxy)ethyl), C₅H₉O (tetrahydrofurfuryl), C₅H₉O (2-tetrahydropyranyl), C₁₃H₂₇ (tridecyl), and C₂₂H₄₅ (behenyl). This aliphatic chain can contain heteroatoms as ether groups, as well as aromatic fragments like benzene rings.
R²═CH₄N (methylamine), C₃H₆N (2-ethylamine), C₃H₈N (3-propylamine), C₄H₁₀N (2-(dimethylamino)ethyl), C₆H₁₄N (2-(diethylamino)ethyl), C₅H₁₂N (3-(dimethylamino)propyl), and C₆H₁₂NO (N-morpholinyl ethyl).

R³═C₃H₅O₂ (2-carboxyethyl), C₄H₇O₂ (3-carboxypropyl), and C₅H₉O₂ (carboxybutyl).

R⁴, R⁵, and R⁶═H (hydrogen) and CH₃ (methyl).
And where:
x, y, and z are natural numbers within the following ranges:
x=from 4 to 900.
y=from 4 to 900.
z=from 4 to 900.
x, y, and z could appear as random sequences.

The average molecular masses in number of terpolymers are enclosed between 1,200 and 664,200 g·mol⁻¹.

The following alkyl acrylic monomers employed to synthesize the random acrylic terpolymers object of this disclosure, which does not imply any limitation but are described as an example: methyl acrylate, ethyl acrylate, butyl acrylate, pentyl acrylate, iso-bornyl acrylate, iso-butyl acrylate, tert-butyl acrylate, hexyl acrylate, 2-ethylhexyl acrylate, 3,5,5-trimethylhexyl acrylate, 2-methoxyethyl acrylate, 2-phenoxyethyl acrylate, 4-tert-butylcyclohexyl acrylate, octyl acrylate, iso-decyl acrylate, decyl acrylate, lauryl acrylate, tridecyl acrylate, octadecyl acrylate, and behenyl acrylate. On the other hand, the aminoalkyl acrylates culled for the disclosure, which does not imply any limitation: 2-aminoethyl acrylate, 2-aminoethyl methacrylate, 2-(dimethylamino)ethyl acrylate, 2-(dimethylamino)ethyl methacrylate, 3-aminopropyl acrylate, 3-(dimethylamino)propyl acrylate, 3-(dimethylamino)propyl methacrylate, 2-(diethylamino)ethyl acrylate, 2-(diethylamino)ethyl methacrylate, 2-N-ethylmorpholine methacrylate. Finally, the carboxyalkyl acrylates selected in this disclosure, which does not imply any limitation: 2-carboxyethyl acrylate, 3-carboxypropyl acrylate, 4-carboxybutyl acrylate, 2-carboxyethyl methacrylate, 3-carboxypropyl methacrylate, and 4-carboxybutyl methacrylate.

The method includes adding an adequate amount of random acrylic terpolymer based on alkyl acrylate/aminoalkyl acrylate/carboxyalkyl acrylate in crude oils with API densities from 3 to 40° API, at a concentration comprised among 10 and 2,000 ppm, to induce the removal of emulsified water of aforementioned crude oils.

The present disclosure is described as reference to a specific number of examples, which should be considered as illustrative but not limiting. Once the random acrylic terpolymers based on alkyl acrylate/aminoalkyl acrylate/carboxyalkyl acrylate were obtained, these were characterized by means of the following instrumental techniques:

1.—¹H and ¹³C Nuclear Magnetic Resonance (NMR) using a Bruker™ Avance III HD spectrometer, operating at 300 MHz and 75 MHz, respectively, using deuterated chloroform (CDCl₃) as solvent and tetramethylsilane (TMS) as reference.

2.—Fourier Transform-Infrared Spectroscopy (FTIR), using a Thermo Nicolet™ AVATAR 330 spectrometer and the method of film technique with the software OMNIC™ version 7.0.

3.—Size Exclusion Chromatography (SEC), using an Agilent™ model 1100 chromatograph, with PLgel column, and employing tetrahydrofuran (THF) as eluent to calculate the distribution of molecular masses of the random acrylic terpolymers and the polydispersity indexes (I).

The average molecular masses and the polydispersity indexes of random acrylic terpolymers based on alkyl acrylate/aminoalkyl acrylate/carboxyalkyl acrylate are listed in Tables 1 and 2, which does not imply any limitation:

Table 1 shows the results for the poly(alkyl-aminoalkyl-carboxyalkyl) acrylates (R¹=n-butyl, R²=2-(dimethylamino)ethyl, R³=2-carboxyethyl, R⁴, R⁵, and R⁶=hydrogen) corresponding to the AAmC-1 series, which does not imply any limitation:

TABLE 1
Average molecular masses in number (M̅ₙ̅ ) and polydispersity indexes (/)
determined by SEC, weight ratio of monomers and synthesis method of
the random terpolymers based on alkyl acrylate/aminoalkyl
acrylate/carboxyalkyl acrylate of the AAmC-1 series.

| | Weight | | | |
|---|---|---|---|---|
| | ratio of | | | |
| | A/Am/C | | | Polydispersity |
| | monomers | Synthesis | M̅ₙ̅ | index |
| Terpolymer | (wt %) | method | (g · mol⁻¹) | (/) |
| AAmC 6131 | 60/10/30 | Semi-continuous | 36,914 | 2.61 |
| AAmC 6221 | 60/20/20 | Semi-continuous | 13,707 | 2.12 |
| AAmC 6311 | 60/30/10 | Semi-continuous | 15,039 | 2.18 |
| AAmC 7121 | 70/10/20 | Semi-continuous | 20,695 | 2.25 |
| AAmC 7211 | 70/20/10 | Semi-continuous | 7,505 | 1.89 |
| AAmC 8111 | 80/10/10 | Semi-continuous | 15,617 | 2.25 |
| AAmC 9551 | 90/5/5 | Semi-continuous | 26,381 | 2.48 |

Table 2 displays the results for the poly(alkyl-aminoalkyl-carboxyalkyl) acrylates (R¹=n-butyl, R²=2-(dimethylamino)ethyl, R³=2-carboxyethyl, R⁴, R⁵, and R⁶=hydrogen) corresponding to the AAmC-2 series, which does not imply any limitation:

TABLE 2
Average molecular masses in number (M̅ₙ̅ ) and polydispersity indexes (/)
determined by SEC, weight ratio of monomers and synthesis method
of the random terpolymers based on alkyl acrylate/aminoalkyl
acrylate/carboxyalkyl acrylate of the AAmC-2 series.

| | Weight | | | |
|---|---|---|---|---|
| | ratio of | | | |
| | A/Am/C | | | Polydispersity |
| | monomers | Synthesis | M̅ₙ̅ | index |
| Terpolymer | (wt %) | method | (g · mol⁻¹) | (/) |
| AAmC 6132 | 60/10/30 | Semi-continuous | 14,984 | 2.55 |
| AAmC 6222 | 60/20/20 | Semi-continuous | 9,833 | 1.95 |
| AAmC 6312 | 60/30/10 | Semi-continuous | 12,720 | 2.15 |
| AAmC 7122 | 70/10/20 | Semi-continuous | 11,085 | 2.10 |
| AAmC 7212 | 70/20/10 | Semi-continuous | 6,854 | 1.76 |
| AAmC 8112 | 80/10/10 | Semi-continuous | 11,839 | 2.02 |
| AAmC 9552 | 90/5/5 | Semi-continuous | 16,418 | 2.58 |

### EXAMPLES

The following examples are presented to illustrate the spectroscopic characteristics of the alkyl acrylate/aminoalkyl acrylate/carboxyalkyl acrylate random terpolymers employed as dehydrating agents of crude oils with API densities between 3 and 40° API. These examples should not be considered as limitation of what is hereby claimed.

### AAmC-1 and AAmC-2 Series

Alkyl acrylic/aminoalkyl acrylic/carboxyalkyl acrylic random terpolymers:

I.R. v (cm⁻¹): 3,448, 2,962, 2,875, 1,735, 1,591, 1,467, 1,382, 1,255, and 1,172.

¹H NMR δ (ppm): 4.17, 4.04, 2.92, 2.91, 2.69, 1.9, 2.37, 2.28, 1.6, 1.37, and 0.94.

¹³C NMR δ (ppm): 64.46, 62.03, 60.96, 60.14, 45.01, 41.42, 36.00, 34.00, 33.57, 30.5, 19.10, 14.14, and 13.76.

Evaluation of the random terpolymers based on alkyl acrylate/aminoalkyl acrylate/carboxyalkyl acrylate as dehydrating agents in crude oils with API densities between 3 and 40° API. Different concentrated solutions of each synthesized random terpolymers were prepared from 10 to 50 wt %, and using solvents with boiling point within the range of 35 and 200° C., such as: dichloromethane, methanol, ethanol, isopropanol, chloroform, benzene and its derivatives, toluene, xylene, turbosine, and naphtha; individually or as a mixture, so that the dosage consisted of small volumes of the solution and therefore, it was avoided the influence of the solvent in the stability of the crude oil emulsion. The random terpolymers based on alkyl acrylate/aminoalkyl acrylate/carboxyalkyl acrylate were assessed at dosages between 10 and 2,000 ppm. The random acrylic terpolymers were simultaneously evaluated and compared with a commercial formulation (FDH-1) widely used in the crude oil industry.

Table 3 describes the constituent polymers of the FDH-1 commercial formulation. It should be noted that the aforementioned chemical product is a mixture of several block polyether terpolymers; conferring either emulsion breaking ability, coalescing of the water droplets or water clarifying function on formulation. The fact that the FDH-1 formulation consists of several dehydrating basics (non-functionalized polyethers) increases its production cost. In contrast, the random terpolymers based on alkyl acrylate/aminoalkyl acrylate/carboxyalkyl acrylate are basics that work without the need of combination as a formulation, considering that a single molecule possesses the three demulsifying functions (breaker, coalescer, and clarifier), which represents an advantage compared with the commercial formulation, furthermore, the novel random terpolymers are made in one-pot synthesis (emulsion polymerization) and do not require an additional mixing stage.

TABLE 3
Chemical components of the FDH-1 commercial
formulation, including the average molecular masses
in number (M̅ₙ̅ ) and PPO/PEO ratio (wt %).
FDH-1 Formulation

| | M̅ₙ̅ | PPO/PEO ratio |
|---|---|---|
| Key name | (g · mol⁻¹) | (wt %) |
| TP 89 | 7,750 | 90/10 |
| TP 03 | 5,330 | 70/30 |
| TP 14 | 3,050 | 60/40 |
| TP 71 | 1,400 | 90/10 |

Evaluation procedure is described as follows: one aliquot of a dissolution of the random terpolymer based on alkyl acrylate/aminoalkyl acrylate/carboxyalkyl acrylate was added into a graduated bottle of 150 mL; afterwards, 100 mL of crude oil was poured into, the same procedure was followed for the commercial formulation. An additional bottle containing only the crude oil was included in the test (labeled as blank). The first reading was carried out right before placing the bottles into the temperature-controlled water bath. The readings of removed water amount were periodically taken during assessment time, which was of an overall time of 5 h. Random acrylic terpolymers and the FDH-1 commercial formulation were evaluated at dosages within 10 and 2,000 ppm.

Table 4 displays the characterization of the crude oils employed to evaluate the performance as demulsifying agents of the random terpolymers based on alkyl acrylate/aminoalkyl acrylate/carboxyalkyl acrylate.

TABLE 4
Physicochemical characterization and properties of crude oils.

| Property | CM1 | CM2 | CM3 |
|---|---|---|---|
| API gravity (°) | 7.55^{a} | 6.11^{b} | 4.55 |
| Salt content (lb · mbb⁻¹) | 2732.0 | 37.0 | 38.7^{c} |
| Paraffins content (wt %) | 3.90 | 0.73 | 2.25 |
| Runoff temperature (° C.) | −15.00 | +6 | +6 |
| Distillation water (vol %) | 25.0 | 66.4 | 62.0 |
| Water and sediments (vol %) | 27.0 | 68.0 | 60.4 |
| Kinematic viscosity (mm² · s⁻¹) @ 25° C. | 2945.15 | 111063 | 482167^{d} |
| Aaverage molecular mass in number by | 415.2 | 1140.0 | 1066.0 |
| cryoscopy (g · mol⁻¹) | | | |
| Average molecular mass in number by | 2132.1 | 1205.0 | 1635.1 |
| osmometry (g · mol⁻¹) | | | |
| n-heptane insolubles (wt %) | 14.78 | 9.99 | 14.98 |
| Saturates (wt %) | 20.35 | 12.02 | 16.23 |
| Aromatics (wt %) | 36.17 | 51.10 | 33.31 |
| Resins (wt %) | 26.43 | 20.37 | 33.01 |
| Asphaltenes (wt %) | 16.95 | 16.45 | 17.31 |

^{a}API gravity of 11.15° API after dehydration.
^{b}API gravity of 12.89° API after dehydration.
^{c}Sample was diluted.
^{d}Apparent Brookfield viscosity.

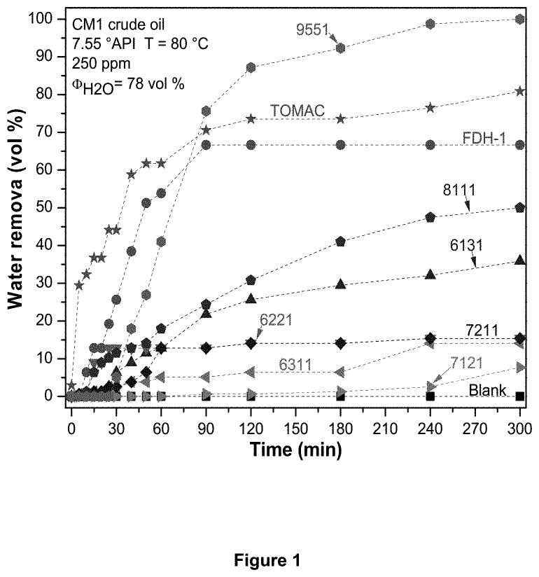

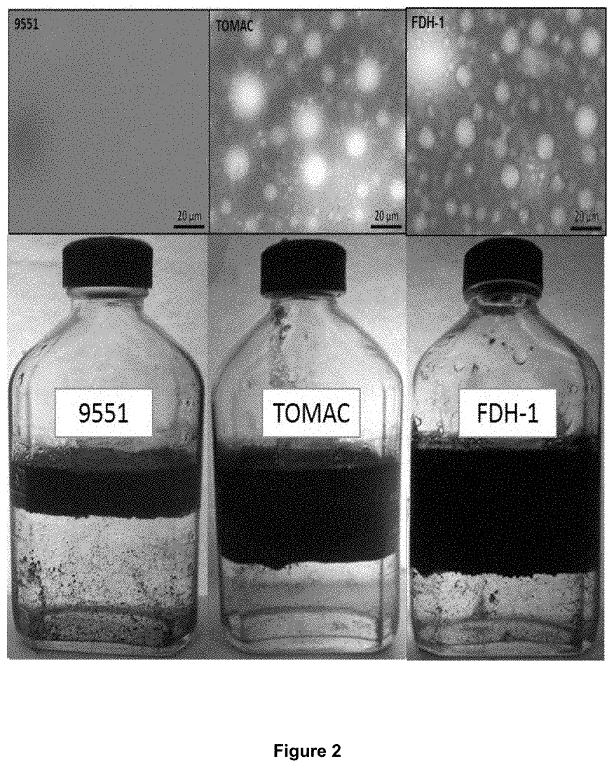

FIGS. 1, 3, 6, 8, 10, and 12 display as an example the demulsifying activity of the random terpolymers based on alkyl acrylate/aminoalkyl acrylate/carboxyalkyl acrylate, which should not be considered as limitation; while FIGS. 2, 4, 5, 7, 9, 11, and 13 exhibit the images of the corresponding bottles and optical micrographs after the assessment.

FIG. 1 shows the effect of the composition of the AAmC-1 series (alkylacrylic-aminoalkylacrylic-carboxyalkylacrylic random terpolymers) in the dewatering efficiency; the terpolymers were dosed in a crude oil of 7.55° API (CM1) at 250 ppm. The TOMAC ionic liquid displayed the best coalescence rate until 60 min of the test, however, at 90 min the terpolymer AAmC 9551 exhibited a better water removal efficiency (76 vol %) compared with that of TOMAC (71 vol %). After that time, it can be seen an increase of the coalescence rate of the terpolymer AAmC 9551, achieving a total water removal at 300 min. At the end of the assessment, the TOMAC ionic liquid removed 81 vol % of the emulsified water. Regarding the FDH-1 commercial formulation, it displayed a better performance as demulsifier at the first 60 min of the test (54 vol %) than the AAmC 9551 terpolymer (41 vol %). Notwithstanding, at 90 min, the FDH-1 barely removed 67 vol %, which remained constant until the end of the evaluation. On the other hand, the AAmC 8111 and AAmC 6131 terpolymers reached a maximum efficiency of 50 and 36 vol %, respectively. The AAmC 6221, AAmC 7211, AAmC 6311, and AAmC 7121 terpolymers showed water removal efficiencies inferior to 20 vol %.

FIG. 2 compares the water removal efficiencies of the AAmC 9551 terpolymer, the FDH-1 formulation, and the TOMAC ionic liquid. Firstly, the AAmC 9551 terpolymer induced a homogeneous rupture of the phases, whereas FDH-1 and TOMAC created a slightly non-homogeneous rupture. The clarification of the aqueous phase of all the previously mentioned products was comparable; however, the water removal efficiency of the alkylacrylic-aminoalkylacrylic-carboxyalkylacrylic random terpolymer was superior; combined with its capacity of generating a homogeneous rupture, the acrylic terpolymer represents a clear advantage as demulsifying agent in contrast with the FDH-1 and TOMAC products.

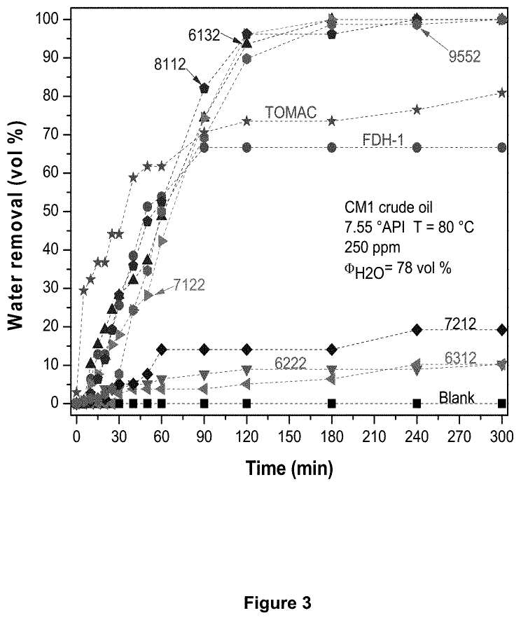

FIG. 3 reports the dehydrating performance of the AAmC-2 series in the CM1 crude oil (7.55° API), dosed at 250 ppm. As can be observed, there was an increase in the water removal efficiency when the molecular mass of the terpolymer was diminished, being these novel acrylic random terpolymers more efficient than the FDH-1 and TOMAC products. The AAmC 9552, AAmC 8112, AAmC 7122, and AAmC 6132 terpolymers removed all the emulsified water at 300, 240, 180, and 180 min, respectively. Therefore, the composition of random acrylic terpolymers is an important parameter, because it has influence over the coalescence rate and, hence, over the demulsifying performance, granting them a greater versatility than the acrylic bipolymers [15,16,19]. In this way, the variation in the composition of the alkyl acrylate, aminoalkyl acrylate, and carboxyalkyl acrylate monomers promotes a major demulsifying activity of random acrylic terpolymer in the crude oil. If the aminoacrylic ratio increases, the performance to remove emulsified water drastically decreases until 19 vol %, as it was observed for the AAmC 7212, AAmC 6222 and AAmC 6312 terpolymers. Hence, there exists an optimal composition of the three monomers.

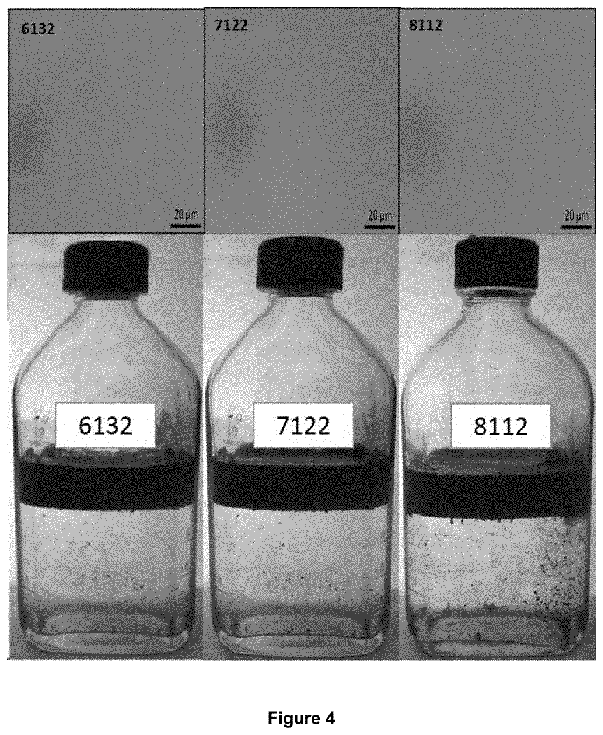

FIG. 4 reveals that the AAmC 6132, AAmC 7122, and AAmC 8112 terpolymers were able to remove all the emulsified water from CM1 crude oil (7.55° API), which was confirmed by the optical micrographs. Additionally, all of them present a homogeneous rupture and good clarification of removed water.

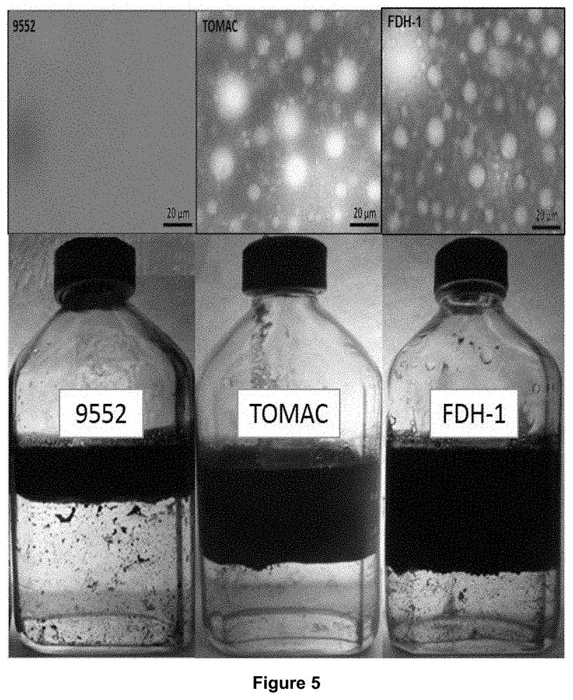

FIG. 5 exhibits the lightly non-homogeneous rupture of the AAmC 9552 terpolymer, which was comparable to that of the FDH-1 and TOMAC products; however, the AAmC 9552 terpolymer removed all the emulsified water, same as the AAmC 6132, AAmC 7122, and AAmC 8112 terpolymers, in contrast with the noticeably lower water removal efficiency of the FDH-1 and TOMAC products, which was confirmed by the optical micrograph. Finally, all the demulsifiers presented a good clarification.

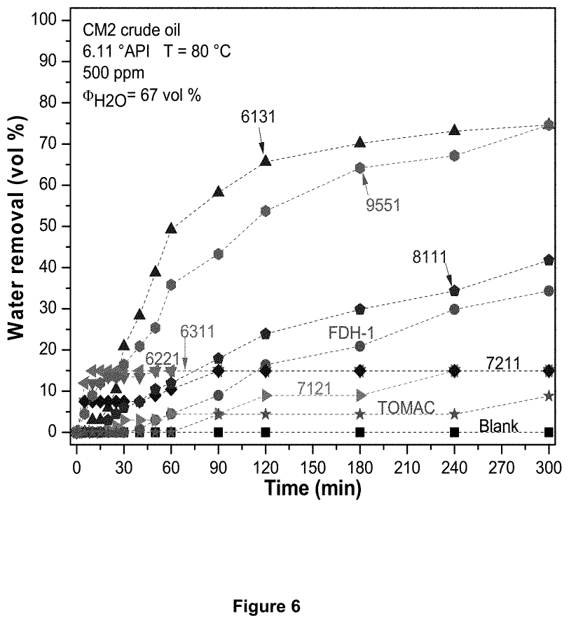

FIG. 6 displays the performance of the AAmC-1 series dosed at 500 ppm in the CM2 heavy crude oil (6.11° API). The AAmC 6131 and AAmC 9551 terpolymers reached at the end of the assessment a maximal removal of 75 vol %. Despite that, during the experiment, the AAmC 6131 terpolymer exhibited a higher performance as coalescer than the AAmC 9551 terpolymer. The AAmC 8111 terpolymer was able to remove 42 vol % of water. The AAmC 7211 and AAmC 7121 terpolymers showed efficiencies lower than 15 vol %, while the FDH-1 and TOMAC products barely removed 34 and 9 vol %, respectively.

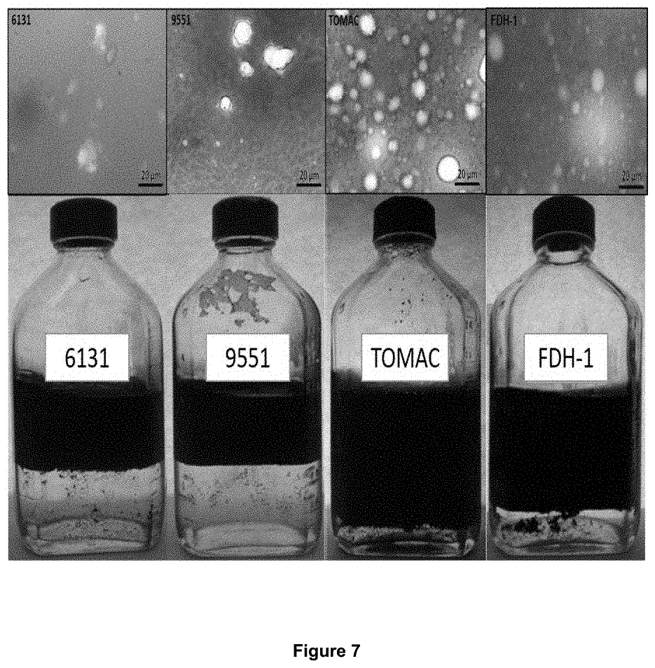

FIG. 7 compares the homogeneous rupture of the AAmC 6131 and AAmC 9551 terpolymers with that of the FDH-1 and TOMAC products. It is noteworthy to mention that the AAmC 6131, FDH-1, and TOMAC products presented a similar clarification of the removed water, being superior than that of the AAmC 9551 terpolymer. Despite of this behavior, the water removal efficiency of AAmC 6131 and AAmC 9551 terpolymer was higher than the efficiency of the FDH-1 and TOMAC products. Optical micrographs support aforementioned statement.

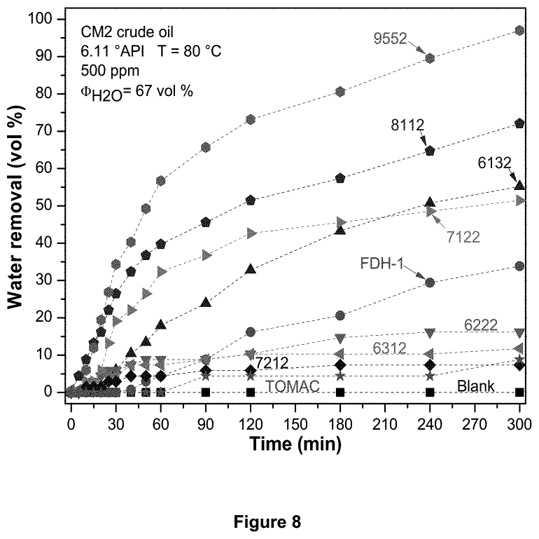

FIG. 8 depicts the dehydrating activity of the AAmC-2 series dosed at 500 ppm in the CM2 crude oil (6.11° API), where a lower molecular mass of random acrylic terpolymer enhances the performance as demulsifying agent, in comparison with the AAmC-1 series. The AAmC 9552 terpolymer displayed the highest coalescence rate and water removal efficiency, achieving 97 vol %, followed by the AAmC 8112 terpolymer with an efficiency of 72 vol %. Until 180 min of the determination, the AAmC 7122 terpolymer displayed better coalescence rate than the AAmC 6132 terpolymer; however, the effectiveness as demulsifier agent was very similar, removing 52 and 55 vol %, respectively. The aforementioned terpolymers exhibited a demulsifying activity remarkably superior than the FDH-1 and TOMAC products. The AAmC 6222, AAmC 6312, and AAmC 7212 terpolymers showed a water removal efficiency lower than 17 vol %.

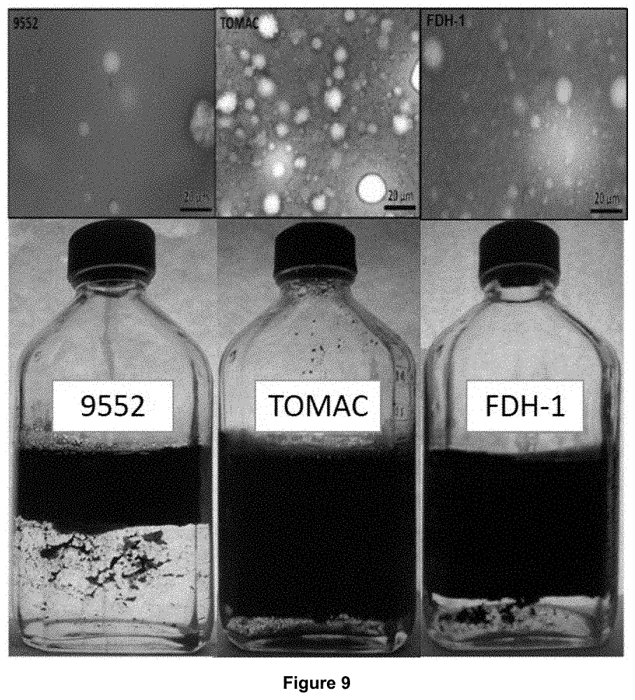

FIG. 9 shows that, even though the AAmC9552 terpolymer exhibited a slightly heterogeneous rupture, its breaking ability is comparable to that of the FDH-1, and TOMAC products. Besides, the aforementioned products possessed a comparable clarification of removed water; yet the water removal efficiency of AAmC 9552 is stranded out, as can be observed in the optical micrographs, where the remaining emulsified water exhibited a monodisperse system; while the FDH-1 and TOMAC products displayed a polydisperse system, with an average droplet size of 5 and 10 μm, respectively. It is clear that a high efficiency demulsifier first eliminates the tiniest water droplets. That is the case of the novel acrylic random terpolymers which reduce the average droplet size and the polydispersity of the remaining water droplets in the oil phase.

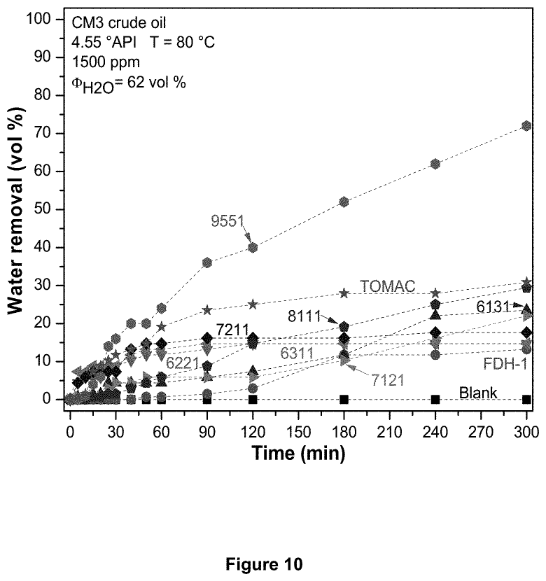

FIG. 10 shows the performance as demulsifying agents of the AAmC-1 series dosed at 1500 ppm in CM3 (4.55° API) crude oil. The AAmC 9551 terpolymer displayed the highest water removal efficiency, 72 vol % at the end of the test; whereas the AAmC 8111, AAmC 7211, AAmC7121, AAmC6311, AAmC6221, and AAmC6131 terpolymers removed less than 30 vol %. The FDH-1 and TOMAC products scarcely removed 13 and 31 vol %, respectively. In this sense, water removal efficiency drastically diminishes with a crude oil with lower API gravity. Still, the AAmC 9551 terpolymer is significantly more efficient as demulsifying agent than the FDH-1 and TOMAC products.

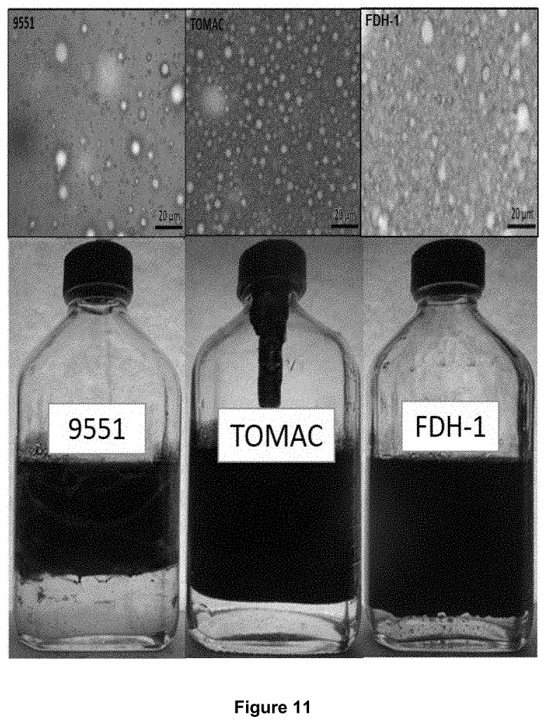

FIG. 11 shows the homogeneous rupture of AAmC 9551 terpolymer and TOMAC ionic liquid, in contrast with the non-homogeneous rupture of FDH-1 formulation. The former and the latter displayed a comparable clarification, though it was overtaken by the TOMAC ionic liquid. As can be observed in the optical micrographs, the residual emulsion left by the AAmC 9551 presented less water droplets with homogeneous distribution, in contrast with that of the FDH-1 and TOMAC products, where it can be appreciated a great amount of water droplets with very polydisperse size.

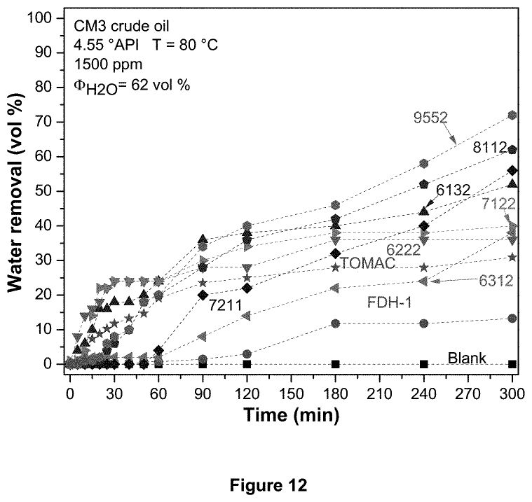

FIG. 12 displays the demulsifying activity of the acrylic terpolymers of the AAmC-2 series dosed at 1500 ppm in CM3 crude oil. Similarly to AAmC-1 series, the AAmC 9552 terpolymer removed 72 vol % of the emulsified water at the end of the assessment. On the other hand, the AAmC 8112, AAmC 7211, and AAmC 6132 terpolymers reached 62, 56, and 52 vol %, respectively; while AAmC 7122, AAmC 6312, and AAmC 6222 terpolymers removed 40, 38, and 36 vol %, correspondingly. However, it should be noted that all the acrylic terpolymers displayed a better demulsifying activity than the FDH-1 and TOMAC products.

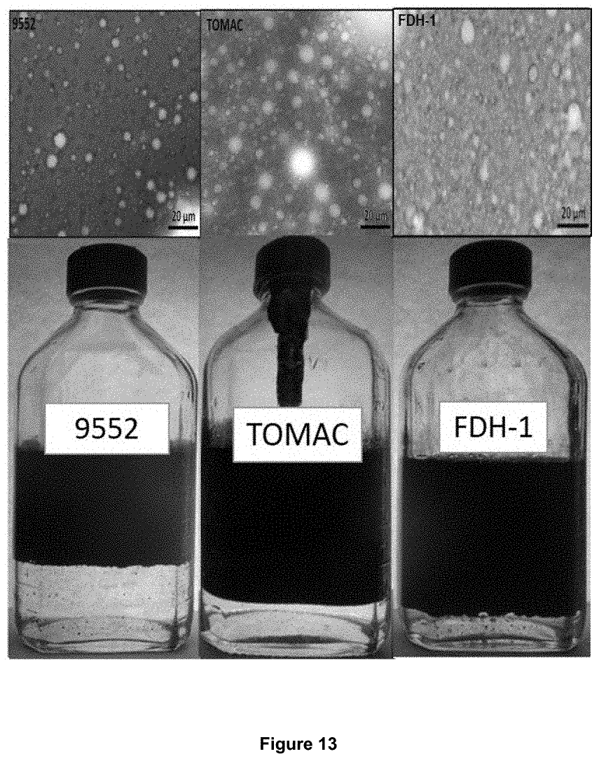

FIG. 13 displays the homogeneous rupture of the AAmC 9552 terpolymer, similar to that of the TOMAC ionic liquid, in contrast with that of the FDH-1 formulation, which was slightly non-homogeneous. Regarding the clarification of the aqueous phase, both AAmC 9552 terpolymer and TOMAC ionic liquid exhibited excellent clarification, superior to that of the FDH-1 formulation. On the other hand, optical micrographs show a greater water droplet distribution when the FDH-1 was dosed, in comparison with that of the AAmC 9552 terpolymer and TOMAC ionic liquid.

While the disclosure has been presented herein with a certain degree of particularity, it is understood that the disclosure is not limited to the embodiments set forth herein, but is to be limited only by the scope of appended claims, including the full range of equivalency to which each element thereof is entitled.

1. A synthesis of a random alkylacrylic-aminoacrylic-carboxyacrylic terpolymer, wherein the random alkylacrylic-aminoacrylic-carboxyacrylic terpolymer is employed as demulsifying agent of crude oil, with API densities from 3 to 40° API, and comprises structural formula (1) and molecular masses within 1,200 and 664,200 g·mol⁻¹: 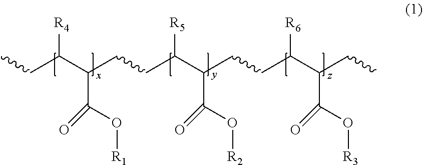
where:
R¹, R², R³, R⁴, R⁵ and R⁶ are independent radicals, represented by the groups mentioned below:
R¹=an aliphatic chain selected from the group consisting of CH₃ (methyl), C₂H₅ (ethyl), C₄H₉ (n-butyl), C₄H₉ (iso-butyl), C₄H₉ (tert-butyl), C₅H₁₁ (pentyl), C₆H₁₃ (n-hexyl), C₆H₁₁ (di(ethyleneglycol)ethylether), C₈H₁₇ (2-ethylhexyl), C₉H₁₉ (3,5,5-trimethylhexyl), C₈H₁₇ (n-octyl), C₈H₁₇ (iso-octyl), C₈H₉ (ethyleneglycol phenylether), C₁₀H₂₁ (n-decyl), C₁₀H₂₁ (isodecyl), C₁₀H₁₉ (10-undecenyl), C₁₀H₁₉ (tert-butylciclohexyl), C₁₂H₂₅ (n-dodecyl), C₁₈H₃₇ (n-octadecyl), C₈H₉O (2-phenoxyethyl), C₃H₇O (2-methoxyethyl), C₅H₁₁O₂ (2-(2-methoxyethoxy)ethyl), C₅H₉O (tetrahydrofurfuryl), C₅H₉O (2-tetrahydropyranyl), C₁₃H₂₇ (tridecyl), and C₂₂H₄₅ (behenyl), wherein the aliphatic chain can contain heteroatoms as ether groups, as well as aromatic fragments like benzene rings;
R²═CH₄N (methylamine), C₃H₆N (2-ethylamine), C₃H₈N (3-propylamine), C₄H₁₀N (2-(dimethylamino)ethyl), C₆H₁₄N (2-(diethylamino)ethyl), C₅H₁₂N (3-(dimethylamino)propyl), and C₆H₁₂NO (N-morpholinyl ethyl);
R³═C₃H₅O₂ (2-carboxyethyl), C₄H₇O₂ (3-carboxypropyl), and C₅H₉O₂ (carboxybutyl);
R⁴, R⁵ and R⁶═H (hydrogen), CH₃ (methyl);
and where:
x, y, and z are natural numbers within the following ranges:
x=from 4 to 900;
y=from 4 to 900; and
z=from 4 to 900; and
wherein “x”, “y”, and “z” could appear as random sequences.

2. The synthesis of random alkylacrylic-aminoacrylic-carboxyacrylic terpolymers, as demulsifying agents of crude oils, according to claim 1, where the alkylacrylic monomer is selected from a group consisting of: methyl acrylate, ethyl acrylate, butyl acrylate, pentyl acrylate, iso-bornyl acrylate, iso-butyl acrylate, tert-butyl acrylate, hexyl acrylate, 2-ethylhexyl acrylate, 3,5,5-trimethylhexyl acrylate, 2-methoxyethyl acrylate, 2-phenoxyethyl acrylate, 4-tert-butylcyclohexyl acrylate, octyl acrylate, iso-decyl acrylate, decyl acrylate, lauryl acrylate, tridecyl acrylate, octadecyl acrylate, and behenyl acrylate.

3. The synthesis of random alkylacrylic-aminoalkylacrylic-carboxyalkylacrylic terpolymers, as demulsifying agents of crude oils, according to claim 1, where the aminoalkylacrylic monomer is selected from a group consisting of: 2-aminoethyl acrylate, 2-aminoethyl methacrylate, 2-(dimethylamino)ethyl acrylate, 2-(dimethylamino)ethyl methacrylate, 3-aminopropyl acrylate, 3-(dimethylamino)propyl acrylate, 3-(dimethylamino)propyl methacrylate, 2-(diethylamino)ethyl acrylate, 2-(diethylamino)ethyl methacrylate, 2-N-ethylmorpholine methacrylate.

4. The synthesis of random alkylacrylic-aminoalkylacrylic-carboxyalkylacrylic terpolymers, as demulsifying agents of crude oils, according to claim 1, where the carboxyalkyl acrylate monomer is selected from a group consisting of: 2-carboxyethyl acrylate, 3-carboxypropyl acrylate, 4-carboxybutyl acrylate, 2-carboxyethyl methacrylate, 3-carboxypropyl methacrylate, and 4-carboxybutyl methacrylate.

5. The synthesis through emulsion polymerization of random alkylacrylic-aminoacrylic-carboxyacrylic terpolymers, in accordance with claim 2, where the monomers are fed from an addition tank, to form a pre-emulsion with the following monomer rates: the alkylacrylic monomer between about 50.0 and about 99.0 wt %, the aminoalkylacrylic between about 0.5 and about 49.5 wt %, and the carboxyalkylacrylic monomers between about 0.5 and about 49.5 wt %.

6. The use of random alkylacrylic-aminoalkylacrylic-carboxyalkylacrylic terpolymers as demulsifying agents of crude oils, according to claim 1, wherein the terpolymer is formulated as a solution employing organic solvents.

7. The use of random alkylacrylic-aminoalkylacrylic-carboxyalkylacrylic terpolymers employed as demulsifying agents of crude oils, in accordance with claim 6, where the organic solvents employed for the formulation possess boiling points between about 35 and about 200° C.

8. The use of random alkylacrylic-aminoalkylacrylic-carboxyalkylacrylic terpolymers employed as demulsifying agents of crude oils, in accordance with claim 6, where the organic solvents employed in the formulation are selected from a group consisting of: dichloromethane, methanol, ethanol, isopropanol, chloroform, benzene, benezene derivatives, toluene, xylene, turbosine, and naphtha; individually or as a mixture of the aforementioned.

9. The use of random alkylacrylic-aminoalkylacrylic-carboxyalkykacrylic terpolymers employed as demulsifying agents of crude oils, in accordance with claim 6, where the concentration of the formulation of the random acrylic terpolymers is within about 10.0 and about 50.0 wt %.

10. The use of random alkylacrylic-aminoalkylacrylic-carboxyalkykacrylic terpolymers employed as demulsifying agents of crude oils, in accordance with claim 6, where the formulations are dosed between about 10 and about 2,000 ppm.

11. A random alkylacrylic-aminoacrylic-carboxyacrylic terpolymer employed as demulsifying agent of crude oil, with API densities from 3 to 40° API, comprising structural formula (1) and molecular masses within 1,200 and 664,200 g·mol⁻¹: 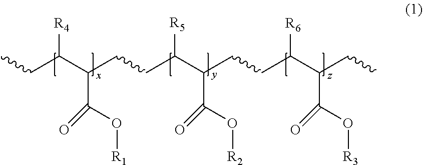
where:
R¹, R², R³, R⁴, R⁵ and R⁶ are independent radicals, represented by the groups mentioned below:
R¹=an aliphatic chain selected from the group consisting of CH₃ (methyl), C₂H₅ (ethyl), C₄H₉ (n-butyl), C₄H₉ (iso-butyl), C₄H₉ (tert-butyl), C₅H₁₁ (pentyl), C₆H₁₃ (n-hexyl), C₆H₁₁ (di(ethyleneglycol)ethylether), C₈H₁₇ (2-ethylhexyl), C₉H₁₉ (3,5,5-trimethylhexyl), C₈H₁₇ (n-octyl), C₈H₁₇ (iso-octyl), C₈H₉ (ethyleneglycol phenylether), C₁₀H₂₁ (n-decyl), C₁₀H₂₁ (isodecyl), C₁₀H₁₉ (10-undecenyl), C₁₀H₁₉ (tert-butylciclohexyl), C₁₂H₂₅ (n-dodecyl), C₁₈H₃₇ (n-octadecyl), C₈H₉O (2-phenoxyethyl), C₃H₇O (2-methoxyethyl), C₅H₁₁O₂ (2-(2-methoxyethoxy)ethyl), C₅H₉O (tetrahydrofurfuryl), C₅H₉O (2-tetrahydropyranyl), C₁₃H₂₇ (tridecyl), and C₂₂H₄₅ (behenyl), wherein the aliphatic chain can contain heteroatoms as ether groups, as well as aromatic fragments like benzene rings;
R²═CH₄N (methylamine), C₃H₆N (2-ethylamine), C₃H₈N (3-propylamine), C₄H₁₀N (2-(dimethylamino)ethyl), C₆H₁₄N (2-(diethylamino)ethyl), C₅H₁₂N (3-(dimethylamino)propyl), and C₆H₁₂NO (N-morpholinyl ethyl);
R³═C₃H₅O₂ (2-carboxyethyl), C₄H₇O₂ (3-carboxypropyl), and C₅H₉O₂ (carboxybutyl);
R⁴, R⁵ and R⁶═H (hydrogen), CH₃ (methyl);
and where:
x, y, and z are natural numbers within the following ranges:
x=from 4 to 900;
y=from 4 to 900; and
z=from 4 to 900; and
wherein “x”, “y”, and “z” could appear as random sequences.
